(19) United States
(12) Patent Application Publication
(10) Pub. No.: US 2023/0055710 A1
(43) Pub. Date: Feb. 23, 2023

(54) PROXIMITY SENSOR AND ELECTRONIC DEVICE

(71) Applicant: ROHM CO., LTD., Kyoto (JP)

(72) Inventors: TAKAHIRO KITAHARA, KYOTO (JP); KOJI SAITO, KYOTO (JP)

(21) Appl. No.: 17/875,799

(22) Filed: Jul. 28, 2022

(30) Foreign Application Priority Data
Aug. 18, 2021 (JP) 2021133200

(51) Int. Cl. G01S 17/04; G01S 7/497

(52) U.S. Cl. CPC G01S 17/04; G01S 7/4972

(57) ABSTRACT

The present disclosure provides a proximity sensor. The proximity sensor includes a light emitting unit, a light receiving unit, a transimpedance amplifier, a capacitor, an amplifying unit, a converting unit and an integrating unit. The light emitting unit irradiates a detection target with light. The light receiving unit detects a reflected light from the detection target. The transimpedance amplifier receives an output of the light receiving unit. The capacitor receives an output of the transimpedance amplifier. The amplifying unit amplifies a difference between an output voltage of the capacitor when a charge corresponding to an ambient light is stored and the output voltage of the capacitor when charges corresponding to the ambient light and the reflected light are stored. The converting unit converts an output of the amplifying unit into a current signal and outputs the current signal. The integrating unit integrates an output of the converting unit.

### TECHNICAL FIELD

The disclosure of the application relates to a proximity sensor and an electronic device.

### BACKGROUND

An optical proximity sensor irradiates the outside of a group (an electronic device such as a smartphone) on which it is mounted with light, and detects the reflected light returning from the outside of the group, thereby detecting whether a detection target approaches (=whether there is a reflection of a detection target) or not.

FIG. 6 shows a diagram of a configuration example of a common proximity sensor. The proximity sensor shown in FIG. 6 consists of a light receiving element PD1, an integration circuit INT1, and switches S1 and S2 that are complementarily turned on/off. The integration circuit INT1 includes an operational amplifier OA1, a capacitor C1 and a switch S3. The integration circuit INT1 is in a standby state w % ben the switch SW3 is turned on, and becomes in a state of performing an integration operation when the switch SW3 is turned off.

### PRIOR ART DOCUMENT

### Patent Publication

[Patent document 1] Japan Patent Publication No. 2012-150022

### SUMMARY OF THE PRESENT DISCLOSURE

### Problems to be Solved by the Disclosure

To enhance the sensitivity of the proximity sensor in FIG. 6, it is necessary to increase a light receiving area of the light receiving element PD1 and reduce a static capacitance of the capacitor C1.

However, the increase in the light receiving area of the light receiving element PD1 increases the parasitic capacitance of the light receiving element PD1. As a result, a feedback rate determined by a ratio of the static capacitance of the capacitor C1 to the parasitic capacitance of the light receiving unit PD1 is reduced, a close-loop gain of the operational amplifier OA1 becomes larger, and a level of noise in an output voltage AOUT of the integration circuit INT1 is increased. When the static capacitance of the capacitor C1 is reduced, the level of noise in the output voltage AOUT of the integration circuit INT1 is also increased.

Accordingly, even if the light receiving area of the light receiving unit PD1 is increased and the static capacitance of the capacitor C1 is reduced, an actual signal-to-noise ratio (SNR) of the proximity sensor shown in FIG. 6 cannot be improved to an ideal SNR (referring to FIG. 7).

The noise in the output voltage AOUT of the integration circuit INT1 includes two elements. One of the elements is voltage fluctuation Δ1 (referring to FIG. 8) generated at the instant of turning off of the switch S3; the other of the elements is voltage fluctuation Δ2 (referring to FIG. 8) generated in the integration operation of the integration circuit INT.

As shown in FIG. 9, the noise in the operational amplifier OA1 includes low-frequency flicker noise and middle/high-frequency thermal noise. Considering an integration time of the integration circuit INT1, the high-frequency thermal noise primarily affects the level of noise in the output voltage AOUT of the integration circuit INT.

Thus, by designing the operational amplifier OA1 to operate at a low speed, the level of noise in the output voltage AOUT of the integration circuit INT1 can be inhibited. However, even if the operational amplifier OA1 operates at a low speed, a stabilization time for the capacitor C1 to perform discharging is increased. As a result, the operational amplifier OA1 operating at a low speed cannot be adopted.

Moreover, it is difficult for the proximity sensor proposed by patent publication 1 to pick up noise light due to the shape designed for a light shielding component, and the above issues remain unresolved.

### Technical Means for Solving the Problem

A proximity sensor disclosed by the application includes: a light emitting unit, configured to irradiate a detection target with light; a light receiving unit, configured to detect a reflected light from the detection target; a transimpedance amplifier, configured to receive an output of the light receiving unit; a capacitor; configured to receive an output of the transimpedance amplifier; an amplifying unit, configured to amplify a difference between an output voltage of the capacitor when a charge corresponding to an ambient light is stored and the output voltage of the capacitor when charges corresponding to the ambient light and the reflected light are stored; a converting unit, configured to convert an output of the amplifying unit into a current signal and output the current signal; and an integrating unit, configured to integrate an output of the converting unit.

An electronic device disclosed by the application includes the proximity sensor in the above configuration.

### Effects of the Disclosure

The proximity sensor and the electronic device disclosed by the present application are capable of inhibiting the noise caused by fluctuation in an output of the integrating unit due to the parasitic capacitance of the light receiving unit.

### BRIEF DESCRIPTION OF THE DRAWINGS

FIG. 1 is a block diagram of a proximity sensor according to an embodiment.

FIG. 2 is a diagram of a brief configuration example of the proximity sensor in FIG. 1.

FIG. 3 is a diagram of a configuration example of a first reference power supply source.

FIG. 4 is a timing diagram of voltages of units of the proximity sensor in FIG. 1.

FIG. 5 is a front view of an appearance of a smartphone according to the embodiment.

FIG. 6 is a diagram of a configuration example of a common proximity sensor.

FIG. 7 is a diagram of characteristics of a signal-to-noise ratio (SNR) of the proximity sensor in FIG. 6.

FIG. 8 is a diagram of characteristics of an output of the proximity sensor in FIG. 6.

FIG. 9 is a diagram of characteristics of noise in an operational amplifier.

### DETAILED DESCRIPTION OF THE EMBODIMENTS

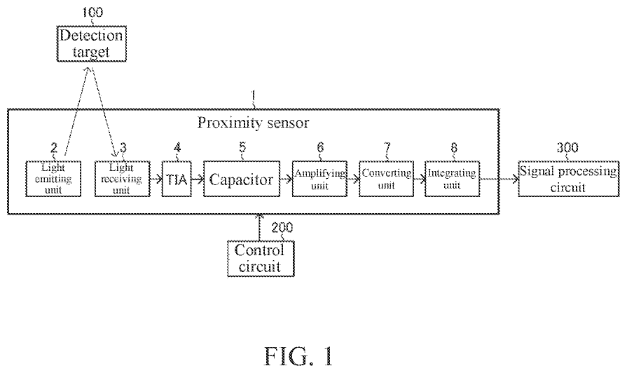

A proximity sensor 1 according to an embodiment shown in FIG. 1 includes a light emitting unit 2, a light receiving unit 3, a transimpedance amplifier 4, a capacitor 5, an amplifying unit 6, a converting unit 7 and an integrating unit 8.

The light emitting unit 2 is configured to irradiate a detection target 100 with light. The light irradiated from the light emitting unit 2 may be visible light, but is expectantly infrared light.

The light receiving unit 3 is configured to detect a reflected light from the detection target 100. The light receiving unit 3 is configured to output a current corresponding to the reflected light.

The transimpedance amplifier 4 is configured to receive an output of the light receiving unit 3. The transimpedance amplifier 4 converts a current signal output from the light receiving unit 3 into a voltage signal and outputs the voltage signal.

The capacitor 5 is configured to receive an output of the transimpedance amplifier 4.

The amplifying unit 6 is configured to amplify a difference between an output voltage of the capacitor 5 when a charge corresponding to an ambient light is stored and the output voltage of the capacitor 5 when charges corresponding to the ambient light and the reflected light are stored.

The converting unit 7 is configured to convert a voltage signal output from the amplifying unit 6 into a current signal and output the current signal.

The integrating unit 8 is configured to integrate an output of the converting unit 7.

A control circuit 200 is configured to control the proximity sensor 1. A signal processing circuit 300 is configured to perform signal processing on an output of the proximity sensor 1.

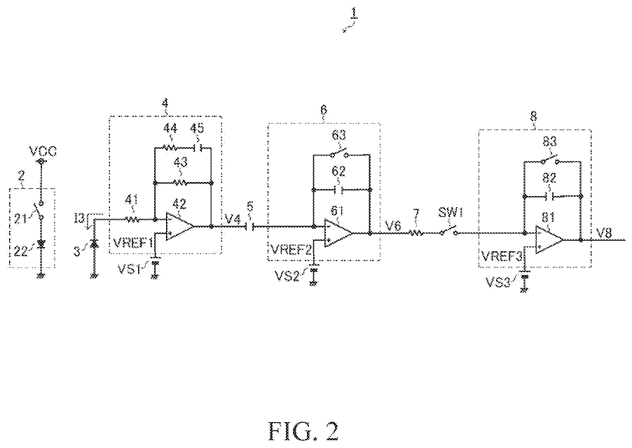

FIG. 2 shows a diagram of a brief configuration example of the proximity sensor 1.

The light emitting unit 2 includes a switch 21 and a light emitting diode (LED) 22. A power supply voltage VCC is applied to one terminal of the switch 21. The other terminal of the switch 21 is connected to an anode of the LED 22. A cathode of the LED 22 is connected to a ground potential. The LED 22 is lit when the switch 21 is turned on, and the LED 22 is off when the switch 21 is turned off.

A photodiode is used as the light receiving unit 3. An anode of the photodiode 3 is connected to the ground potential. A cathode of the photodiode 3 is connected to an input terminal of the transimpedance amplifier 4.

The transimpedance amplifier 4 includes a resistor 41, an operational amplifier 42, resistors 43 and 44, and a capacitor 45. A terminal of the resistor 41 becomes an input terminal of the transimpedance amplifier 4. The other terminal of the resistor 41 is connected to an inverting input terminal of the operational amplifier 42, one terminal of the resistor 43 and one terminal of the resistor 44. The other terminal of the resistor 44 is connected to one terminal of the capacitor 45. The other terminal of the resistor 43 and the other terminal of the capacitor 45 are connected to an output terminal of the operational amplifier 42. A first reference voltage VREF1 output from a first reference power supply source VS1 is supplied to a non-inverting terminal of the operational amplifier 42. Moreover, in order to reduce thermal noise of the transimpedance amplifier 4, it is expected that a consumption current of the operational amplifier 42 is greater than a consumption current of an operational amplifier 61 to be described later, and greater than a consumption current of an operational amplifier 81 to be described later.

One terminal of the resistor 5 is connected to an output terminal of the transimpedance amplifier 4, that is, the output terminal of the operational amplifier 42, the other terminal of the resistor 43 and the other terminal of the resistor 45. The other terminal of the capacitor 5 is connected to an input terminal of the amplifying unit 6. The capacitor 5 receives an output voltage V4 of the transimpedance amplifier 4.

The amplifying unit 6 includes an operational amplifier 61, a capacitor 62 and a switch 63. An inverting input terminal of the operational amplifier 61, one terminal of the capacitor 62 and one terminal of the switch 63 become an input terminal of the amplifying unit 6. The other terminal of the capacitor 62 and the other terminal of the switch 63 are connected to an output terminal of the operational amplifier 61. A second reference voltage VREF2 output from a second reference power supply source VS2 is supplied to a non-inverting input terminal of the operational amplifier 61.

A resistor is used as the converting unit 7. One terminal of the resistor 7 is connected to an output terminal of the amplifying unit 6, that is, the output terminal of the operational amplifier 61, the other terminal of the capacitor 62 and the other terminal of the switch 63. The other terminal of the resistor 7 is connected to an input terminal of the integrating unit 8 via the switch SW1. The converting unit 7 receives an output voltage V6 of the amplifying unit 6. The switch SW1 and a switch 83 to be described later are complementarily turned on/off.

The integrating unit 8 includes an operational amplifier 81, a capacitor 82 and a switch 83. An inverting input terminal of the operational amplifier 81, one terminal of the capacitor 82 and one terminal of the switch 83 become an input terminal of the integrating unit 8. The other terminal of the capacitor 82 and the other terminal of the switch 83 are connected to an output terminal of the operational amplifier 81. A third reference voltage VREF3 output from a third reference power supply source VS3 is supplied to a non-inverting input terminal of the operational amplifier 81. An output voltage V8 of the integrating unit 8, that is, an output of the proximity sensor 1, is supplied to the signal processing circuit 300 (referring to FIG. 1).

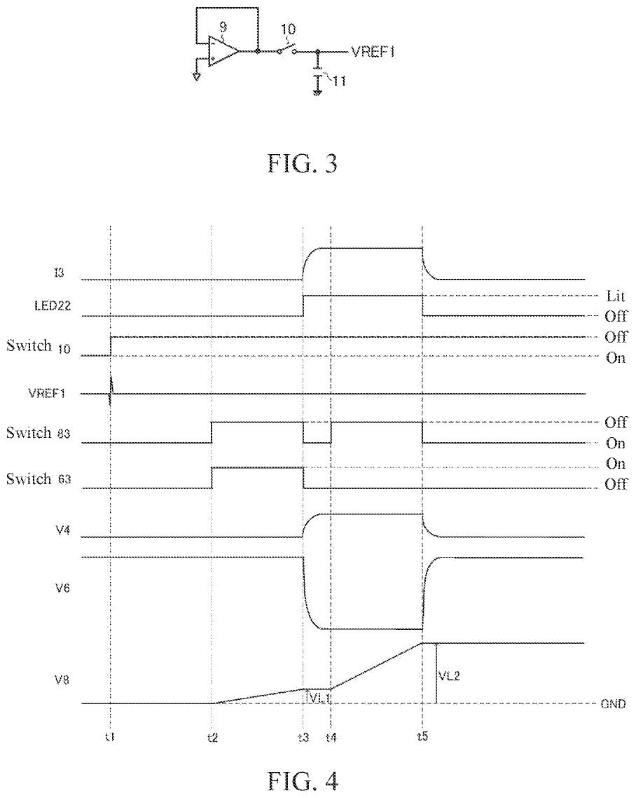

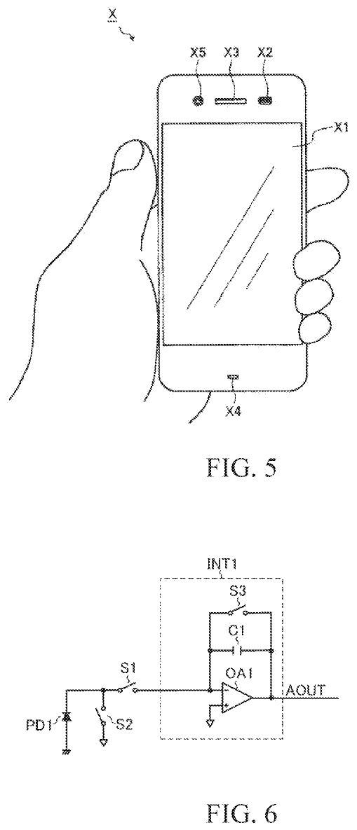

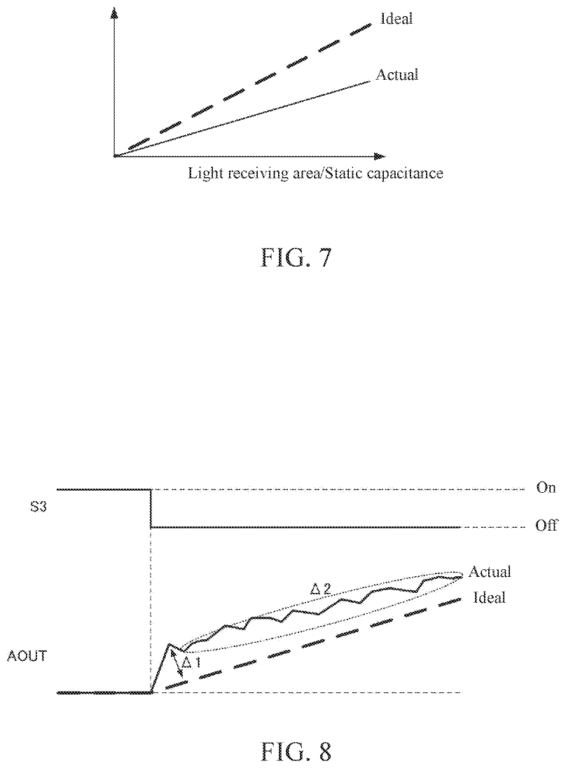

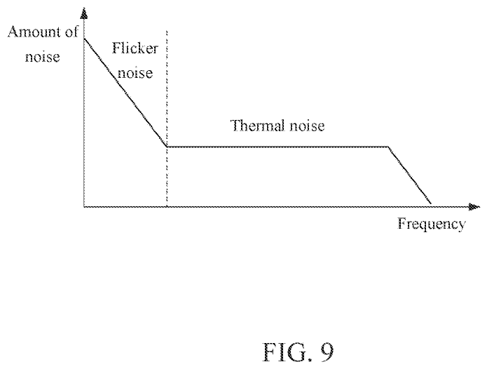

FIG. 3 shows a diagram of a configuration example of the first reference power supply source VS1. The first reference power supply source VS1 includes an operational amplifier 9, a switch 10 and a capacitor 11. A direct-current (DC) bias is supplied to a non-inverting input terminal of the operational amplifier 9. An inverting input terminal of the operational amplifier 9 is connected to an output terminal of the operational amplifier 9 and one terminal of the switch 10. The other terminal of the switch 10 is connected to one terminal of the capacitor 11. The other end of the capacitor 11 is connected to the ground potential. An inter-terminal voltage of the capacitor 11 becomes the first reference voltage VREF1.

In the configuration shown in FIG. 3, the first reference power supply source VS1 is a sample hold circuit. Because the first reference voltage VREF1 is a voltage that is sampled and held, the first reference voltage VREF1 does not fluctuate even if the DC bias supplied to the non-inverting input terminal of the operational amplifier 9 fluctuates.

Each of the second reference power supply source VS2 and the third reference power supply source VS3 is set to the same configuration as the first reference power supply source VS1. When each of the second reference power supply source VS2 and the third reference power supply source VS3 is set to the same configuration as the first reference power supply source VS1, the first to third reference power supply sources VS1 to VS3 may share an operational amplifier, or each of the first to third reference power supply sources VS1 to VS3 may be individually provided with a separate operational amplifier.

A main factor causing fluctuation in an output voltage B8 can be reduced by inhibiting fluctuation in the first to third reference power supply sources VS1 to VS3.

FIG. 4 shows a timing diagram of voltages of units of the proximity sensor 1. The timing diagram shown in FIG. 4 is a timing diagram when the first reference power supply source VS1 is in the configuration shown in FIG. 3.

At a timing t1, the switch 10 is turned off and the first reference voltage VREF1 is sampled and held.

At a timing t2, the switch 83 is turned off, and the integrating unit 8 starts an integration operation. Within a period up to a timing t3 at which the switch 83 is turned on, the integrating unit 8 continues the integration operation. Within a period from the timing t2 to the timing 13, the LED 22 is turned off, the switch 63 is turned on and the amplifying unit 6 becomes fully fed back, and so the capacitor 5 stores only a charge corresponding to the ambient light. Thus, within the period from the timing t2 to the timing 3, the integrating unit 8 integrates only a current corresponding to the ambient light.

At the timing 3, the LED 22 switches from turning off to lighting. Within a period from the timing t3 to a timing t4, that is, within a period after a predetermined time has elapsed from the timing t3, the switch 83 is turned on. Moreover, the predetermined time is a certain time period excluding zero. Accordingly, within a transition period in which lighting of the LED 22 starts to the light receiving unit 3 stably detects the reflected light from the detection target 100, the integrating unit 8 is prevented from integrating a current corresponding to the ambient light and the reflected light. Accordingly, detection accuracy of the reflected light can be enhanced.

After the timing t3, since the switch 63 is turned off and the amplifying unit 6 is not fully fed back, the amplifying unit 6 amplifies a difference between the output voltage of the capacitor 5 when the charge corresponding to only the ambient light is stored and the output voltage of the capacitor 5 when the charges corresponding to the ambient light and the reflected light from the detection target 100 are stored.

At a timing t4, the switch 83 is turned off, and the integrating unit 8 starts an integration operation. Within a period up to a timing t5 at which the switch 83 is turned on, the integrating unit 8 continues the integration operation. Within the period from the timing t4 to the timing t5, the integrating unit 8 integrates only a current corresponding to the reflected light from the detection target 100.

The signal processing circuit 300 calculates a detection value (=VL2−2*VL1), by subtracting twice a value VL1 of the output voltage V8 within a period from the timing t3 to the timing t4 from a value VL2 of the output voltage V8 within a period from the timing 15 to reset of the integrating unit 8, and detects whether the detection target 100 approaches based on the detection value. By subtracting twice the value VL1 from the value VL2, the output can be prevented from including the detection value, which accounts for a main factor causing a shift in the circuit of the proximity sensor 1.

In the proximity sensor 1, at the timing 13, only the charge corresponding to the ambient light is stored in the capacitor 5, and so variations in the ambient light do not affect the waveform of the output voltage V6 or the waveform of the output voltage V8. Thus, the proximity sensor 1 is capable of inhibiting the noise causing fluctuation in the output voltage V8 of the integrating unit 8 due to the variations in the ambient light.

Moreover, in the proximity sensor 1, in the lack of any switch on a route from the output terminal of the transimpedance amplifier 4 to the output terminal of the amplifying unit 6, the output voltage V4 and the output voltage V6 do not fluctuate as being free from influences of a switch upon the start of the integration operation of the integrating unit 8.

In addition, with the transimpedance amplifier 4 and the amplifying unit 6 disposed between the integrating unit 8 and the photodiode 3, the parasitic capacitance of the photodiode 3 does not become the capacitance on the input side of the switch SW1 in respect to the integrating unit 8. Thus, with the switch SW1 disposed on the input side of the integrating unit 8 and without any capacitor on the input side of the switch SW1, the output voltage V8 does not fluctuate due to the influences of switching of the switch SW1. That is to say, the proximity sensor 1 is capable of inhibiting the noise that can cause fluctuation in the output voltage V8 of the integrating unit 8 due to the parasitic capacitance of the photodiode 3.

### <Applications for Smartphones>

FIG. 5 shows an appearance diagram of a smartphone. The smartphone X is a specific example of an electronic device, and from the appearance, includes a display screen X1 (a liquid crystal display, or an electro-luminescence (EL) display), a proximity sensor X2, a speaker X3, a microphone X4 and a camera X5. In the smartphone X, the proximity sensor X2 is implemented by the proximity sensor 1.

When the smartphone X is used for a voice call, the ears and mouth of a user are respectively located close to the speaker X3 and the microphone X4. At this point, the face of the user is located close to the screen X1. When the proximity sensor X2 detects such close distances (for example, about 0 to 5 cm), if the touch panel function of the screen X1 is turned off, unintentional touch operations during the voice call can be timely prevented. Moreover, power consumption of the smartphone X can be reduced if the display screen X1 is turned off during the voice call.

### NOTES

In addition to the embodiments, various modifications may be applied to the configurations of the present disclosure without departing from the scope of the technical inventive subject thereof. It should be understood that all aspects of the embodiment are exemplary rather than restrictive, and it should also be understood that the technical scope of the present disclosure expressed by the embodiment is to be accorded with the appended claims, and includes meanings equivalent to the scope of the claims and all modifications made within the scope.

For example, the proximity sensor 1 may also be mounted in an electronic device other than the smartphone X.

A proximity sensor 1 described above is a configuration (a first configuration) including: a light emitting unit 2, configured to irradiate a detection target 100 with light; a light receiving unit 3, configured to detect a reflected light from the detection target; a transimpedance amplifier 4, configured to receive an output of the light receiving unit; a capacitor 5; configured to receive an output of the transimpedance amplifier; an amplifying unit 6, configured to amplify a difference between an output voltage of the capacitor when a charge corresponding to an ambient light is stored and the output voltage of the capacitor when charges corresponding to the ambient light and the reflected light are stored; a converting unit 7, configured to convert an output of the amplifying unit into a current signal and output the current signal; and an integrating unit 8, configured to integrate an output of the converting unit.

The proximity sensor in the first configuration is capable of inhibiting the noise caused by fluctuation in the output of the integrating unit due to the parasitic capacitance of the light receiving unit.

The proximity sensor in the first configuration may also be a configuration (a second configuration), wherein the transimpedance amplifier includes a first operational amplifier, the amplifying unit includes a second operational amplifier, the integrating unit includes the third operational amplifier, an output of the first operational amplifier is the output of the transimpedance amplifier, an output of the second operational amplifier is the output of the amplifying unit, an output of the third operational amplifier is an output of the integrating unit, and a current consumption of the first operational amplifier is greater than a current consumption of the second operational amplifier and greater than a current consumption of the third operational amplifier.

The proximity sensor in the second configuration is capable of reducing thermal noise of the transimpedance amplifier. Accordingly, the fluctuation in the output of the integrating unit 8 can be further inhibited.

The proximity sensor in the first or second configuration may also be a configuration (a third configuration), when the charge corresponding to the ambient light is stored in the capacitor, the amplifying unit is configured in a manner that the output of the amplifying unit is fully fed back to an input of the amplifying unit.

The proximity sensor in the third configuration is capable of implementing, with a simple configuration, storage of charge corresponding to the ambient light in the capacitor.

The proximity sensor in any one of the first or third configurations may also be a configuration (a fourth configuration), when the charge corresponding to the ambient light and the reflected light are stored in the capacitor, the amplifying unit is configured in a manner that the output of the amplifying unit is not fully fed back to an input of the amplifying unit.

The proximity sensor in the fourth configuration is capable of implementing, with a simple configuration, amplifying the difference between the output voltage of the capacitor when the charge corresponding to the ambient light is stored and the output voltage of the capacitor when the charges corresponding to the ambient light and the reflected light are stored.

The proximity sensor in any one of the first or fourth configurations may also be a configuration (a fifth configuration), the amplifying unit is configured to stop an amplification operation until a predetermined time has elapsed from a timing at which the light emitting unit switches from turning off to lighting.

In the proximity sensor in the fifth configuration, within a transition period in which lighting of the LED starts to the light receiving unit 3 stably detects the reflected light from the detection target, the integrating unit is prevented from integrating a current corresponding to the ambient light and the reflected light. Accordingly, detection accuracy of the reflected light can be enhanced.

The electronic device X described above is a configuration (a sixth configuration) including the proximity sensor of any one of the first to fifth configurations.

The electronic device of the sixth configuration is capable of using the output of the proximity sensor to inhibit the noise that can cause fluctuation in the output of the integrating unit due to the parasitic capacitance of the light receiving unit.

1. A proximity sensor, comprising:
a light emitting unit, configured to irradiate a detection target with light;
a light receiving unit, configured to detect a reflected light from the detection target;
a transimpedance amplifier, configured to receive an output of the light receiving unit;
a capacitor; configured to receive an output of the transimpedance amplifier;
an amplifying unit, configured to amplify a difference between an output voltage of the capacitor when a charge corresponding to an ambient light is stored and an output voltage of the capacitor when a charge corresponding to the ambient light and the reflected light are stored;
a converting unit, configured to convert an output of the amplifying unit into a current signal and output the current signal; and
an integrating unit, configured to integrate an output of the converting unit.

2. The proximity sensor of claim 1, wherein
the transimpedance amplifier includes a first operational amplifier,
the amplifying unit includes a second operational amplifier,
the integrating unit includes the third operational amplifier,
an output of the first operational amplifier is the output of the transimpedance amplifier,
an output of the second operational amplifier is the output of the amplifying unit,
an output of the third operational amplifier is an output of the integrating unit, and
a current consumption of the first operational amplifier is greater than a current consumption of the second operational amplifier and greater than a current consumption of the third operational amplifier.

3. The proximity sensor of claim 1, wherein when the charge corresponding to the ambient light is stored in the capacitor, the amplifying unit is configured in a manner that the output of the amplifying unit is fully fed back to an input of the amplifying unit.

4. The proximity sensor of claim 2, wherein when the charge corresponding to the ambient light is stored in the capacitor, the amplifying unit is configured in a manner that the output of the amplifying unit is fully fed back to an input of the amplifying unit.

5. The proximity sensor of claim 1, wherein when the charge corresponding to the ambient light and the reflected light are stored in the capacitor, the amplifying unit is configured in a manner that the output of the amplifying unit is not fully fed back to an input of the amplifying unit.

6. The proximity sensor of claim 2, wherein when the charge corresponding to the ambient light and the reflected light are stored in the capacitor, the amplifying unit is configured in a manner that the output of the amplifying unit is not fully fed back to an input of the amplifying unit.

7. The proximity sensor of claim 3, wherein when the charge corresponding to the ambient light and the reflected light are stored in the capacitor, the amplifying unit is configured in a manner that the output of the amplifying unit is not fully fed back to an input of the amplifying unit.

8. The proximity sensor of claim 4, wherein when the charge corresponding to the ambient light and the reflected light are stored in the capacitor, the amplifying unit is configured in a manner that the output of the amplifying unit is not fully fed back to an input of the amplifying unit.

9. The proximity sensor of claim 1, wherein the amplifying unit is configured to stop an amplification operation until a predetermined time elapses from a timing at which the light emitting unit switches from turning off to lighting.

10. The proximity sensor of claim 2, wherein the amplifying unit is configured to stop an amplification operation until a predetermined time elapses from a timing at which the light emitting unit switches from turning off to lighting.

11. The proximity sensor of claim 3, wherein the amplifying unit is configured to stop an amplification operation until a predetermined time elapses from a timing at which the light emitting unit switches from turning off to lighting.

12. The proximity sensor of claim 4, wherein the amplifying unit is configured to stop an amplification operation until a predetermined time elapses from a timing at which the light emitting unit switches from turning off to lighting.

13. The proximity sensor of claim 5, wherein the amplifying unit is configured to stop an amplification operation until a predetermined time elapses from a timing at which the light emitting unit switches from turning off to lighting.

14. The proximity sensor of claim 6, wherein the amplifying unit is configured to stop an amplification operation until a predetermined time elapses from a timing at which the light emitting unit switches from turning off to lighting.

15. An electronic device, comprising the proximity sensor of claim 1.

16. An electronic device, comprising the proximity sensor of claim 2.

17. An electronic device, comprising the proximity sensor of claim 3.

18. An electronic device, comprising the proximity sensor of claim 4.

19. An electronic device, comprising the proximity sensor of claim 5.

20. An electronic device, comprising the proximity sensor of claim 9.
